(19) United States
(12) Patent Application Publication
(10) Pub. No.: US 2018/0247430 A1
(43) Pub. Date: Aug. 30, 2018

(54) DISPLAY CONTROL METHOD AND DISPLAY CONTROL APPARATUS

(71) Applicant: FUJITSU LIMITED, Kawasaki-shi (JP)

(72) Inventors: SUSUMU KOGA, Kawasaki (JP); Hiroshi KUWABARA, Suginami (JP); Nobuyasu YAMAGUCHI, Kawasaki (JP); Toshiyuki Yoshitake, Kawasaki (JP); Taichi Murase, Kawasaki (JP); Tomohiro AOYAGI, Toshima (JP)

(73) Assignee: FUJITSU LIMITED, Kawasaki-shi (JP)

(21) Appl. No.: 15/895,807

(22) Filed: Feb. 13, 2018

(30) Foreign Application Priority Data
Feb. 27, 2017 (JP) 2017-035086

(51) Int. Cl. G06T 7/73; G06T 7/13; G06T 19/20; G06T 3/00

(52) U.S. Cl. CPC G06T 7/75; G06T 7/13; G06T 2219/2004; G06T 3/0068; G06T 19/20

(57) ABSTRACT

A display control apparatus includes a memory, and a processor configured to obtain an image including an object, the image being captured by a camera, extract a group of edge lines from the image, determine a plurality of edge lines in accordance with a position of a reference object from among the group of edge lines when the reference object is detected in the image, execute an association process between each of the plurality of edge lines and each of a plurality of ridge lines included in a model corresponding to structure data of the object, the model being obtained from the memory, and superimpose the model on the image in a state in which positions of the plurality of ridge lines correspond to positions of the plurality of edge lines respectively.

### CROSS-REFERENCE TO RELATED APPLICATION

This application is based upon and claims the benefit of priority of the prior Japanese Patent Application No. 2017-35086, filed on Feb. 27, 2017, the entire contents of which are incorporated herein by reference.

### FIELD

The embodiment discussed herein is related to display control technology.

### BACKGROUND

3D computer aided design (CAD) is employed in design of structures of various parts and the like, such as cases of personal computers, heat sinks, and exterior components of smart phones, and molds used to fabricate the structures. A determination as to whether a structure which has been fabricated based on 3D CAD data is the same as a model of a structure of 3D CAD may be made. In this case, an image obtained by capturing the fabricated structure and the model of the structure of the 3D CAD are overlapped with each other, for example, so that the determination is easily made.

Furthermore, as a method for overlapping the captured image and the model with each other, for example, a technique of attaching texture of the captured image to the 3D model, such as an existing building, has been proposed. Furthermore, a technique of generating a position orientation candidate of an initial value based on a substantial position and orientation obtained from an image and obtaining the position and orientation by associating the position orientation candidate with a target object in the image using model information of the target image when a position and orientation of a target object are to be measured, for example, has been proposed. Furthermore, a technique of extracting edges of a product material from an image, extracting a product material model from information on the extracted edges, and comparing the product material model with 3D model information or the like generated when the product material is designed so that arrival of the product material in a plant construction site is determined has been proposed.

For example, the related arts are disclosed in Japanese Laid-open Patent Publication Nos. 2003-115057 and 2014-169990 and International Publication Pamphlet No. WO 2012/117833.

### SUMMARY

According to an aspect of the invention, a display control apparatus includes a memory, and a processor configured to obtain an image including an object, the image being captured by a camera, extract a group of edge lines from the image, determine a plurality of edge lines in accordance with a position of a reference object from among the group of edge lines when the reference object is detected in the image, execute an association process between each of the plurality of edge lines and each of a plurality of ridge lines included in a model corresponding to structure data of the object, the model being obtained from the memory, and superimpose the model on the image in a state in which positions of the plurality of ridge lines correspond to positions of the plurality of edge lines respectively.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a display control apparatus according to an embodiment;

FIG. 2 is a diagram illustrating examples of an imaged structure and edge lines;

FIG. 3 is a diagram illustrating examples of edge lines obtained in accordance with a position of a reference object;

FIG. 4 is a diagram illustrating an example of a model;

FIG. 5 is a diagram illustrating an example of a case where the model is superposed on the structure in a captured image;

FIG. 6 is a diagram illustrating another example of the case where the model is superposed on the structure in the captured image;

FIG. 7 is a flowchart of an example of a display control process according to the embodiment; and

FIG. 8 is a diagram illustrating an example of a computer which executes a display control program.

### DESCRIPTION OF EMBODIMENT

In the related arts, in a case where a structure of a captured image and a model of the structure in 3D CAD are overlapped with each other, if a shape of the structure is line symmetry in vertical and horizontal directions, it may be difficult for a user to determine whether a direction of the model which is superposed on the structure is appropriate. Therefore, the user performs an overlapping operation by trial and error while the direction of the model is changed, for example, that is, an operation for displaying the model superposed on the structure of the captured image may be complicated.

Hereinafter, examples of the embodiment of a display control program, a display control method, and a display control apparatus of the present disclosure will be described in detail with reference to the accompanying drawings. Note that the disclosed technique is not limited by the examples of the embodiment, and the examples of the embodiment described herein may be appropriately combined with each other within a range of consistency.

### EMBODIMENT

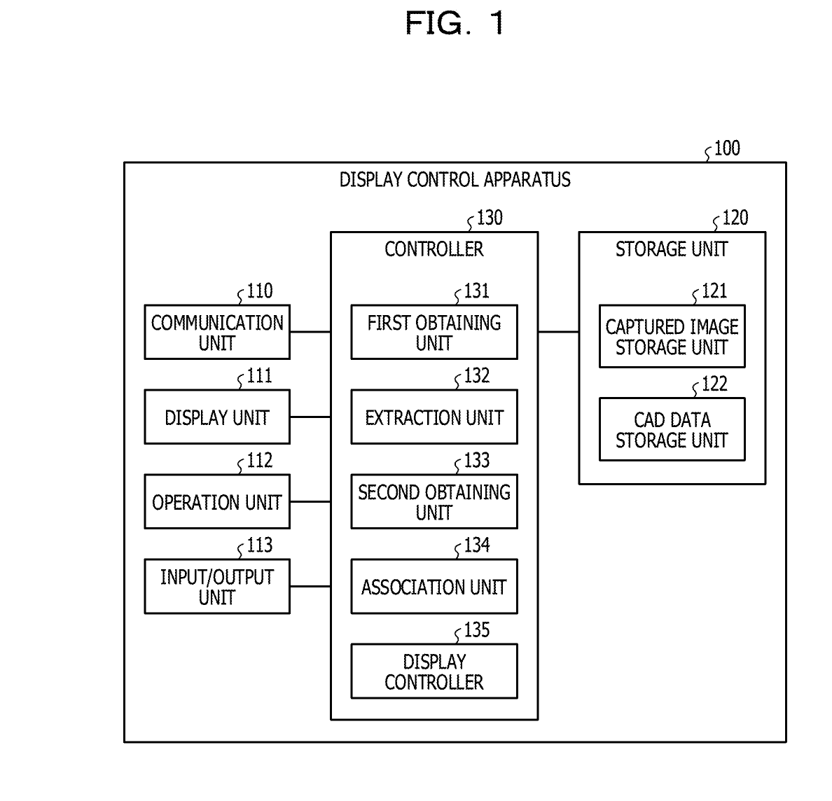

FIG. 1 is a block diagram illustrating an example of a configuration of a display control apparatus according to an embodiment. A display control apparatus 100 of FIG. 1 is an example of a computer which executes an application for performing a display control process of overlapping a captured image obtained by imaging a structure and a model of the structure in 3D CAD with each other. Examples of the display control apparatus 100 include a stationary personal computer. The examples of the display control apparatus 100 further include, in addition to the stationary personal computer, a portable personal computer and a tablet terminal.

The display control apparatus 100 obtains a captured image including a structure obtained by imaging performed by an imaging apparatus. The display control apparatus 100 extracts a plurality of edge lines from the obtained captured image. When detecting a reference object in the obtained captured image, the display control apparatus 100 obtains a predetermined number of edge lines in accordance with a position of the reference object from among the plurality of extracted edge lines. The display control apparatus 100 associates each of a predetermined number of obtained edge lines with a corresponding one of a plurality of ridge lines included in the model corresponding to structure data with reference to a storage unit which stores the structure data of the structure (hereinafter also referred to as “CAD data”). The display control apparatus 100 performs display such that the model is superposed on the captured image in an orientation in which positions of the ridge lines individually associated with a predetermined number of edge lines correspond to positions of the edge lines associated with the ridge lines. In this way, the display control apparatus 100 may simplify an operation of displaying the model on the captured image in a superposing manner.

As illustrated in FIG. 1, the display control apparatus 100 includes a communication unit 110, a display unit 111, an operation unit 112, an input/output unit 113, a storage unit 120, and a controller 130. Note that the display control apparatus 100 may include a functional unit, such as various input devices or an audio output device, in addition to the functional units illustrated in FIG. 1.

The communication unit 110 is realized by a network interface card (NIC) or the like. The communication unit 110 is connected to another information processing apparatus through a network, not illustrated, in a wired manner or a wireless manner and is a communication interface which controls communication of information with other information processing apparatuses.

The display unit 111 is a display device which displays various information. The display unit 111 is realized by a liquid crystal display or the like as a display device, for example. The display unit 111 displays various screens including a display screen input by the controller 130.

The operation unit 112 is an input device which accepts various operations performed by a user of the display control apparatus 100. The operation unit 112 is realized by a keyboard, a mouse, or the like as an input device. The operation unit 112 outputs an operation input by the user as operation information to the controller 130. Note that the operation unit 112 may be realized by a touch panel as the input device, and the display device of the display unit 111 and the input device of the operation unit 112 may be integrated.

The input/output unit 113 is a memory card Reader/Writer (R/W), for example. The input/output unit 113 reads a captured image and CAD data stored in a memory card and outputs the captured image and the CAD data to the controller 130. Furthermore, the input/output unit 113 stores an overlapping image output from the controller 130 in the memory card, for example. Note that an SD memory card or the like may be used as a memory card.

The storage unit 120 is realized by a storage device, such as a random access memory (RAM), a semiconductor memory element including a flash memory, a hard disk, or an optical disc, for example. The storage unit 120 includes a captured image storage unit 121 and a CAD data storage unit 122. Furthermore, the storage unit 120 stores information to be used in a process performed by the controller 130.

The captured image storage unit 121 stores input captured images. The captured image storage unit 121 stores a captured image obtained by capturing a structure fabricated based on CAD data in 3D CAD by the imaging apparatus, for example.

The CAD data storage unit 122 stores input CAD data. The CAD data storage unit 122 stores CAD data which is structure data of the structure generated by a computer which executes the 3D CAD, for example.

Furthermore, the CAD data storage unit 122 stores information on the model of the structure which is generated based on the CAD data and which is associated with the CAD data. Note that use of the CAD data facilitates matching between the structure and the model when a meter kilogram, second (MKS) system of a metric, for example, is used for the CAD data and is also used for a reference object included in the captured image. Furthermore, other unit systems including an Imperial system may be used as long as the same unit system is used for the CAD data and the reference object.

The controller 130 is realized when a central processing unit (CPU), a micro processing unit (MPU), or the like executes a program stored in the storage device in a RAM serving as a work area. Alternatively, the controller 130 may be realized by an integrated circuit, such as an application specific integrated circuit (ASIC) or a field programmable gate array (FPGA).

The controller 130 includes a first obtaining unit 131, an extraction unit 132, a second obtaining unit 133, an association unit 134, and a display controller 135 and realizes or executes functions and operations of information processing described below. Note that an internal configuration of the controller 130 is not limited to the configuration illustrated in FIG. 1 and the controller 130 may have any configuration as long as the information processing described below is performed. Furthermore, the controller 130 stores the captured image and the CAD data supplied from the input/output unit 113 in the captured image storage unit 121 and the CAD data storage unit 122, respectively. Note that the controller 130 may obtain a captured image and CAD data from another information processing apparatus through the communication unit 110 instead of an input of the captured image and the CAD data from the input/output unit 113.

The first obtaining unit 131 activates an application for performing a display control process when the user instructs activation of the application. When the application is activated, the first obtaining unit 131 receives a designation of a captured image and CAD data. When receiving the designation of a captured image and CAD data, the first obtaining unit 131 executes preprocessing. The first obtaining unit 131 obtains the designated captured image from the captured image storage unit 121 and displays the captured image in the display unit 111 in the preprocessing. Furthermore, the first obtaining unit 131 outputs the obtained captured image to the extraction unit 132. Specifically, the first obtaining unit 131 obtains a captured image including the structure captured by the imaging apparatus.

The first obtaining unit 131 reads the designated CAD data from the CAD data storage unit 122, analyzes the CAD data, and generates a model of the structure which may be displayed by augmented reality (AR) based on the CAD data in the preprocessing. Note that the generated model includes ridge lines indicating a contour of the model and a reference object, that is, a marker, used to identify the model. Specifically, the model includes a reference object corresponding to the reference object included in the captured image. Furthermore, the reference object included in the model is also included in the CAD data so that a position on the structure is specified in advance when the CAD data is generated. Specifically, the reference object included in the structure and the reference object included in the model are set to the same position. The first obtaining unit 131 stores information on the generated model in the CAD data storage unit 122 after associating the model information with the CAD data which is an analysis target. Note that the model may be generated when the ridge lines of the model are used by the association unit 134.

The extraction unit 132 extracts a plurality of edge lines from the captured image when the captured image obtained by the first obtaining unit 131 is input. Note that the extraction unit 132 uses straight lines as the edge lines to be extracted. When extracting the plurality of edge lines, the extraction unit 132 outputs the captured image and the plurality of extracted edge lines to the second obtaining unit 133.

When the captured image and the plurality of extracted edge lines are input from the extraction unit 132, the second obtaining unit 133 executes a process of detecting a reference object, for example, a marker, in the captured image. The second obtaining unit 133 determines whether the reference object has been detected in the captured image. When the determination is negative, the second obtaining unit 133 outputs an instruction for manually performing association, the plurality of extracted edge lines, and the captured image to the association unit 134.

When the determination is affirmative, the second obtaining unit 133 obtains a predetermined number of edge lines in accordance with the position of the reference object from among the plurality of extracted edge lines. The second obtaining unit 133 obtains four edge lines surrounding the reference object positioned on the structure in the captured image, for example. Note that the second obtaining unit 133 may obtain the plurality of edge lines surrounding the reference object by extracting the edge lines using 4 neighborhood retrieval or the like, for example. Furthermore, the predetermined number of edge lines may be an arbitrary number as long as a position, a direction, and a size of the structure included in the captured image may be specified. Furthermore, a predetermined number of edge lines preferably form a shape surrounding the reference object, that is, a rectangle shape, for example. The second obtaining unit 133 outputs the captured image, information on the detected reference object, and a predetermined number of obtained edge lines to the association unit 134.

In other words, when detecting the reference object in the obtained captured image, the second obtaining unit 133 obtains a predetermined number of edge lines in accordance with the position of the reference object from among the plurality of extracted edge lines. Furthermore, when detecting the reference object positioned on the structure, the second obtaining unit 133 obtains a predetermined number of edge lines surrounding the reference object from among the plurality of extracted edge lines. Moreover, the second obtaining unit 133 obtains a predetermined number of edge lines which form a shape surrounding the reference object.

When receiving the captured image, the information on the detected reference object, and a predetermined number of obtained edge lines from the second obtaining unit 133, the association unit 134 reads information on the model corresponding to the CAD data specified by the CAD data storage unit 122. The association unit 134 specifies coordinate axes, that is, X, Y, and Z axes, of the structure included in the captured image based on the information on the detected reference object, that is, a calibration pattern which is information including the direction and the size of the reference object. Furthermore, the association unit 134 specifies coordinate axes of the model, that is, X, Y, and Z axes, based on information on the read model.

The association unit 134 associates each of a predetermined number of obtained edge lines with a corresponding one of the plurality of ridge lines of the model based on the specified coordinate axes of the structure and the specified coordinate axes of the model. Specifically, the association unit 134 associates a predetermined number of edge lines obtained using the reference object as a reference with the corresponding ridge lines of the model, that is, the ridge lines having the positional relationships among the ridge lines corresponding to the positional information among a predetermined number of edge lines. Specifically, the association unit 134 may superpose the model on the structure using the edge lines surrounding the reference object and the corresponding ridge lines even if a position of the reference object included in the structure and a position of the reference object included in the model are slightly shifted from each other.

On the other hand, when receiving the instruction for manually performing association, the plurality of extracted edge lines, and the captured image from the second obtaining unit 133, the association unit 134 reads information on a model corresponding to the CAD data specified by the CAD data storage unit 122. The association unit 134 displays the structure of the captured image and the model in parallel and causes the display unit 111 to display a plurality of extracted edge lines and the plurality of ridge lines of the model in a selectable manner.

The association unit 134 receives a selection of a predetermined number of edge lines and a number of ridge lines corresponding to a predetermined number of edge lines performed by the user on the structure in the displayed captured image and the model. The association unit 134 associates each of a predetermined number of edge lines with a corresponding one of the plurality of ridge lines of the model in response to the received selection.

After the association, the association unit 134 changes a magnification of the model and rotates the model after the association so that positions of the ridge lines associated with a predetermined number of edge lines correspond to orientations corresponding to the positions of the edge lines associated with the ridge lines. Specifically, the association unit 134 calculates a rotary movement matrix of the model based on the ridge lines corresponding to the edge lines. The association unit 134 performs movement and rotation in a 3D space after adjusting a size of the model such that the ridge lines of the model overlap with the corresponding edge lines of the structure in the captured image based on the obtained rotary movement matrix. The association unit 134 outputs the captured image and the adjusted model to the display controller 135. Specifically, the association unit 134 adjusts the position, the size, and the orientation of the model based on the obtained rotary movement matrix and outputs the adjusted model to the display controller 135. Note that the adjustment of the model may be performed by the display controller 135.

In other words, the association unit 134 associates each of a predetermined number of obtained edge lines with a corresponding one of the plurality of ridge lines included in the model corresponding to the structure data with reference to the CAD data storage unit 122 which stores the structure data of the structure. Furthermore, the association unit 134 associates a predetermined number of edge lines with a predetermined number of the plurality of ridge lines included in the model such that the positional relationship among the ridge lines corresponds to the positional relationship among a predetermined number of edge lines. The association unit 134 specifies coordinate axes of the structure and coordinate axes of the model based on the reference object included in the captured image and the reference object included in the model and associates each of a predetermined number of edge lines with a corresponding one of the plurality of ridge lines based on the specified coordinate axes.

When receiving the captured image and the adjusted model from the association unit 134, the display controller 135 generates a display screen in which the adjusted model is superposed on the captured image and displays the generated display screen in the display unit 111. Specifically, the display controller 135 performs display such that the model is superposed on the captured image in an orientation in which positions of the ridge lines individually associated with a predetermined number of edge lines correspond to the positions of the edge lines associated with the ridge lines. The display controller 135 stores the display screen in which the model is superposed on the captured image in a memory card of the input/output unit 113 as a superposed image in response to an instruction issued by the user, for example.

After the superposed display is performed, the display controller 135 determines whether the application is to be terminated in accordance with an input performed by the user, for example. When the determination is negative, the display controller 135 instructs the first obtaining unit 131 to receive a designation of a next captured image and next CAD data. When the determination is affirmative, the display controller 135 performs a process of terminating the application so as to terminate the display control process.

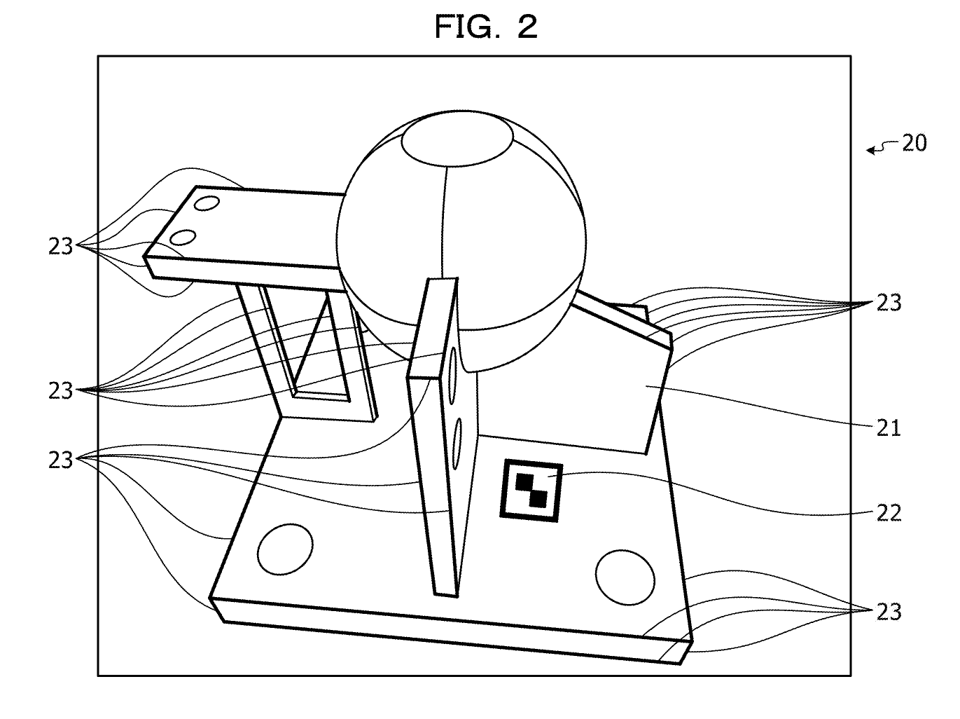

Here, a concrete example will be described with reference to FIGS. 2 to 6. FIG. 2 is a diagram illustrating examples of the imaged structure and the edge lines. As illustrated in FIG. 2, a captured image 20 includes a structure 21. Furthermore, a marker 22 is attached to the structure 21 as a reference object. The extraction unit 132 extracts a plurality of edge lines 23 from the captured image 20. Note that straight lines are used as the edge lines in the examples of FIG. 2, and therefore, an outline of a portion corresponding to a sphere in an upper portion in the structure is not extracted as an edge line. However, edge lines other than straight lines may be extracted if a structure does not have straight lines. When extracting the plurality of edge lines 23, the extraction unit 132 outputs the captured image 20 and the plurality of extracted edge lines 23 to the second obtaining unit 133.

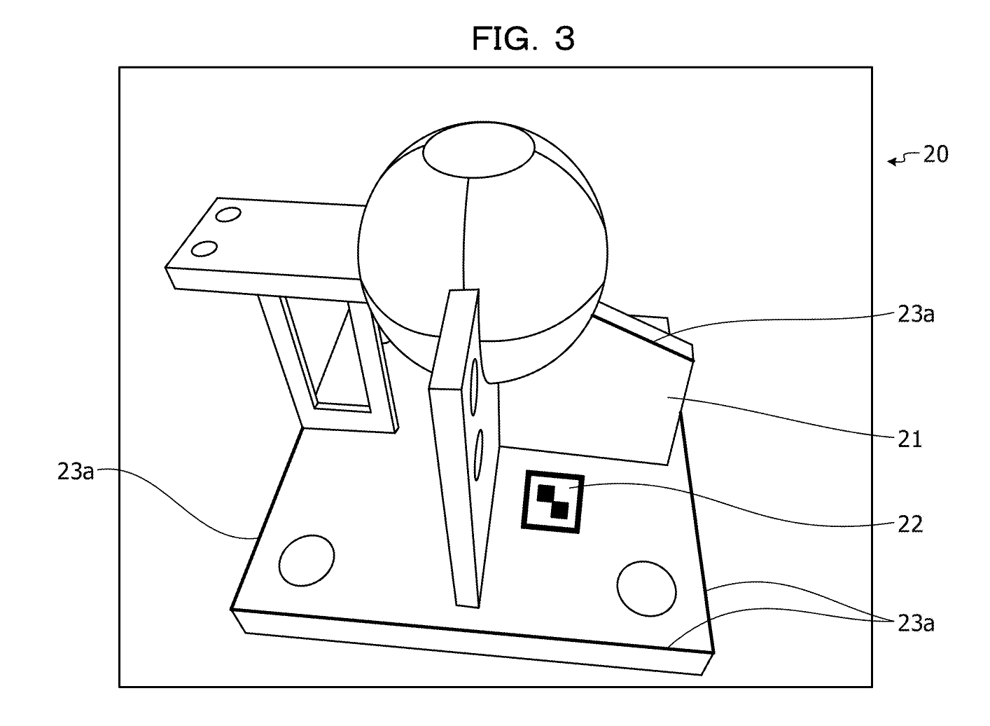

When the captured image 20 and the plurality of extracted edge lines 23 are input from the extraction unit 132, the second obtaining unit 133 executes a process of detecting the marker 22 on the captured image 20. FIG. 3 is a diagram illustrating examples of the edge lines obtained in accordance with a position of the reference object. As illustrated in FIG. 3, when detecting the marker 22 in the captured image 20, the second obtaining unit 133 obtains four edge lines 23a surrounding the marker 22 in the plurality of extracted edge lines 23. The second obtaining unit 133 outputs the captured image 20, information on the marker 22, and the four edge lines 23a to the association unit 134.

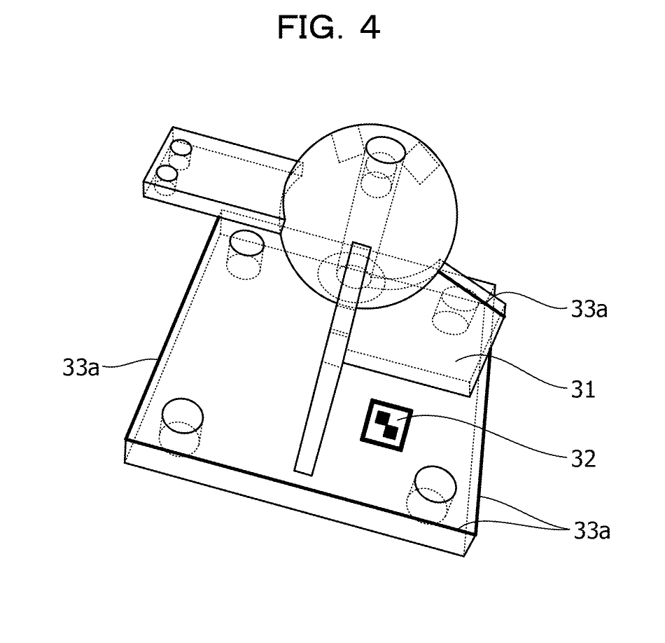

When receiving the captured image 20, the information on the marker 22, and the four edge lines 23a, the association unit 134 reads information on a model corresponding to specified CAD data from the CAD data storage unit 122. FIG. 4 is a diagram illustrating an example of the model. As illustrated in FIG. 4, a model 31 indicating the structure 21 is generated from CAD data of the structure 21 included in the captured image 20 and is displayed as augmented reality (AR). Furthermore, a marker 32 is similarly attached to the position of the marker 22 in the structure 21.

The association unit 134 specifies coordinate axes of the structure 21 and coordinate axes of the model 31 based on information on the markers 22 and 32, for example, directions (inclinations) and sizes of the markers 22 and 32. The association unit 134 associates the four edge lines 23a with a plurality of ridge lies 33a of the model 31 in which the positional relationship among the ridge lines corresponds to the positional relationship among the edge lines 23a based on the specified coordinate axes of the structure 21 and the specified coordinate axes of the model 31.

The association unit 134 changes a magnification of the model 31 and rotates the model 31 after the association so that positions of the ridge lines 33a associated with the four edge lines 23a correspond to orientations in the positions of the edge lines 23a associated with the ridge lines 33a. Specifically, the association unit 134 performs movement and rotation in the 3D space after adjusting a size of the model 31 such that the ridge lines 33a of the model are superposed on the corresponding edge lines 23a of the structure 21. The association unit 134 outputs the captured image 20 and the adjusted model 31 to the display controller 135.

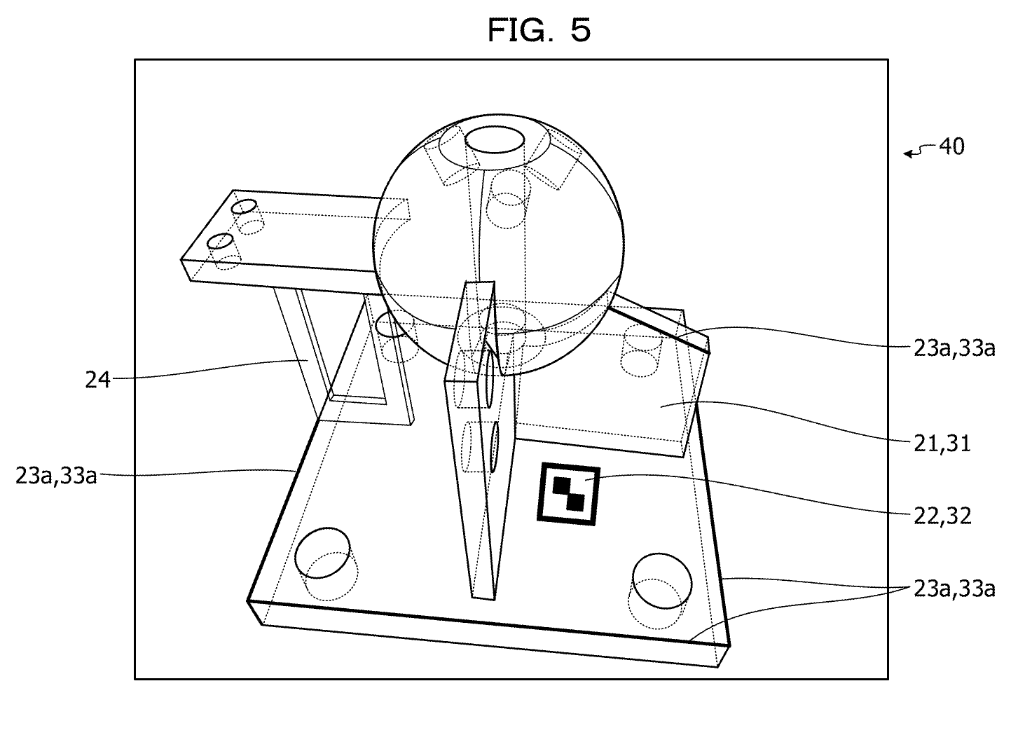

When receiving the captured image 20 and the adjusted model 31 from the association unit 134, the display controller 135 generates a display screen in which the adjusted model 31 is superposed on the captured image 20 and displays the generated display screen in the display unit 111. FIG. 5 is a diagram illustrating an example of a case where the model is superposed on the structure in the captured image. As illustrated in FIG. 5, the structure 21 of the captured image 20 and the model 31 overlap with each other in a display screen 40. The markers 22 and 32 overlap with each other, and the four edge lines 23a and the corresponding four ridge lies 33a overlap with each other. As described above, since the display control apparatus 100 may perform display such that the model 31 is superposed on the structure 21 of the captured image 20 only by receiving designations of a captured image and CAD data performed by the user, and therefore, an operation by the user may be facilitated when the superposed display is performed. Furthermore, in the example of FIG. 5, it is apparent that a member 24 of the structure 21 does not exist in the model 31 based on the CAD data, and therefore, a determination as to whether the structure 21 is fabricated based on the CAD data may be easily made. Note that, in FIG. 5, although only portions of the ridge lies 33a which overlap with the edge lines 23a are displayed by heavy lines, portions which do not overlap with the edge lines 23a may be similarly displayed by heavy lines as illustrated in FIG. 4.

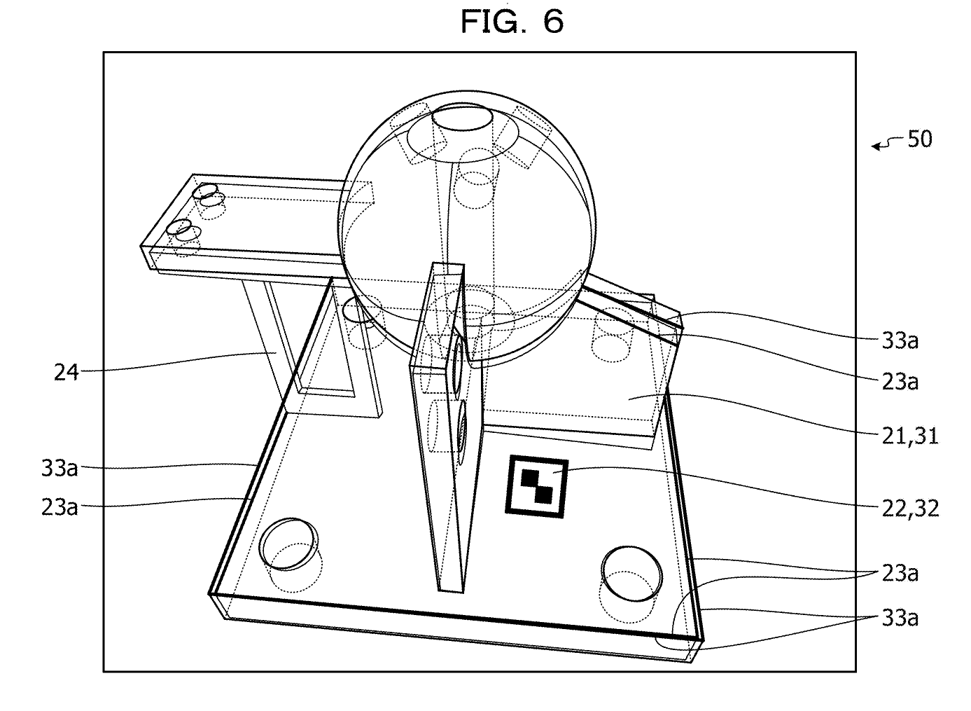

FIG. 6 is a diagram illustrating another example of the case where the model is superposed on the structure in the captured image. Although a display screen 50 illustrated in FIG. 6 is displayed such that the structure 21 of the captured image 20 overlaps with the model 31, the structure 21 and the model 31 are shifted from each other, for example. In this case, the markers 22 and 32 overlap with each other. However, the four edge lines 23a and the corresponding four ridge lies 33a do not overlap with each other, although they are located in the vicinity of each other. As with the case of FIG. 5, the member 24 of the structure 21 does not exist in the model 31 based on the CAD data. In this way, in the example of FIG. 6, the shift between the structure 21 and the model 31 is easily recognized.

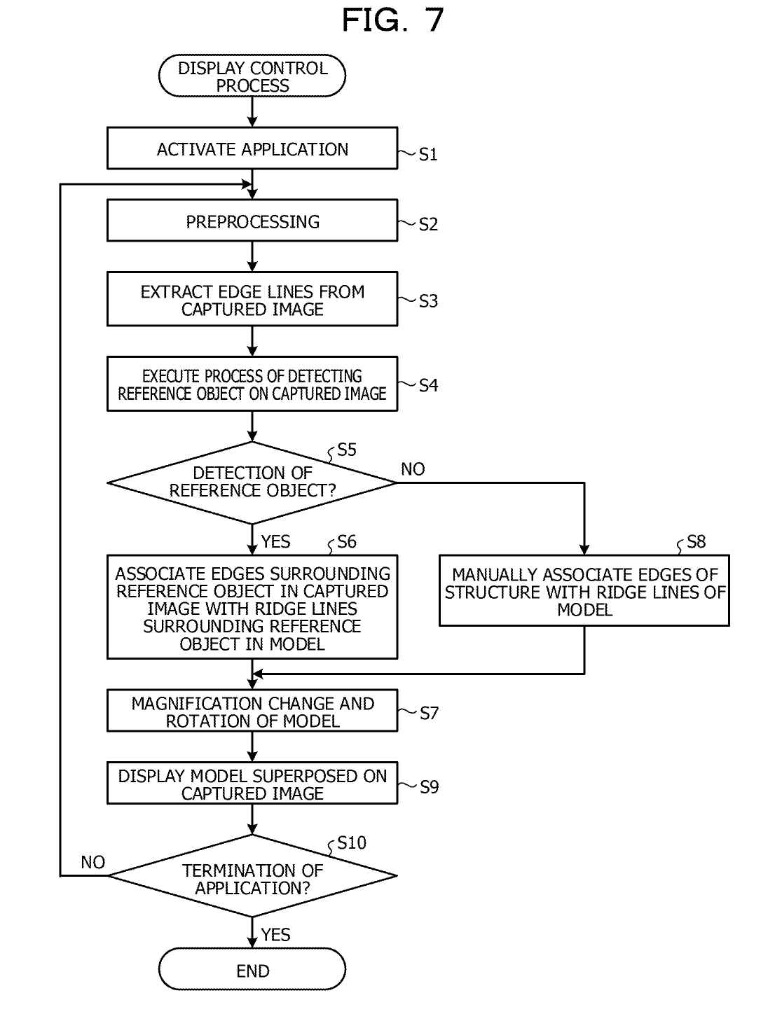

Next, an operation of the display control apparatus 100 according to the first embodiment will be described. FIG. 7 is a flowchart of an example of a display control process according to the embodiment.

The first obtaining unit 131 activates an application for performing a display control process when the user instructs activation of the application (step S1). When the application is activated, the first obtaining unit 131 receives a designation of a captured image and CAD data. When receiving the designation of a captured image and CAD data, the first obtaining unit 131 executes preprocessing (step S2). Specifically, the first obtaining unit 131 obtains the captured image from the captured image storage unit 121 and outputs the obtained captured image to the extraction unit 132. Furthermore, the first obtaining unit 131 generates a model of the structure with reference to the CAD data storage unit 122 and stores information on the generated model in the CAD data storage unit 122.

The extraction unit 132 extracts a plurality of edge lines from the captured image when the captured image obtained by the first obtaining unit 131 is input (step S3). When extracting the plurality of edge lines, the extraction unit 132 outputs the captured image and the plurality of extracted edge lines to the second obtaining unit 133.

When the captured image and the plurality of extracted edge lines are input from the extraction unit 132, the second obtaining unit 133 executes a process of detecting a reference object on the captured image (step S4). The second obtaining unit 133 determines whether a reference object has been detected in the captured image (step S5). When the determination is affirmative (Yes in step S5), the second obtaining unit 133 obtains a predetermined number of edge lines in accordance with a position of the reference object in the plurality of extracted edge lines. The second obtaining unit 133 outputs the captured image, information on the detected reference object, and a predetermined number of obtained edge lines to the association unit 134.

When receiving the captured image, the information on the detected reference object, and a predetermined number of obtained edge lines from the second obtaining unit 133, the association unit 134 reads information on a model corresponding to the CAD data specified by the CAD data storage unit 122. The association unit 134 associates edge lines which surround the reference object included in the captured image with ridge lines which surround the reference object included in the model (step S6).

The association unit 134 changes a magnification of the model and rotates the model after the association so that positions of the ridge lines individually associated with a predetermined number of edge lines correspond to orientations corresponding to the positions of the edge lines associated with the ridge lines (step S7). The association unit 134 outputs the captured image and the adjusted model which has been subjected to the magnification change and the rotation to the display controller 135.

Referring back to step S5, when the determination is negative (No in step S5), the second obtaining unit 133 outputs a manual instruction for manually performing association, the plurality of extracted edge lines, and the captured image to the association unit 134. When receiving the manual instruction, a predetermined number of extracted edge lines, and the captured image from the second obtaining unit 133, the association unit 134 displays the edge lines of the structure and the ridge lines of the model in a selectable manner. The association unit 134 manually associates the edge lines of the structure with the ridge lines of the model by a user operation (step S8), and the process proceeds to step S7.

When receiving the captured image and the adjusted model from the association unit 134, the display controller 135 generates a display screen in which the adjusted model is superposed on the captured image and displays the generated display screen in the display unit 111 (step S9). After the superposed display is performed, the display controller 135 determines whether the application is to be terminated in accordance with an input performed by the user, for example (step S10).

When the determination is negative (No in step S10), the display controller 135 instructs the first obtaining unit 131 to receive a designation of a next captured image and next CAD data, and the process returns to step S2. When the determination is affirmative (step S10: Yes), the display controller 135 performs a process of terminating the application so as to terminate the display control process. By this, the display control apparatus 100 may simplify an operation of displaying the model on the captured image in a superposing manner.

Note that, although the image captured in advance is obtained in the foregoing embodiment, the present disclosure is not limited to this. For example, an imaging apparatus may be disposed in the display control apparatus 100, and an adjusted model based on CAD data of a structure may be superposed on a structure included in a captured image captured by the display control apparatus 100 for display.

Furthermore, although the model is automatically superposed on the structure in the captured image using the edge lines surrounding the reference object when the reference object attached to the structure included in the captured image is successfully detected, the present disclosure is not limited to this. For example, when the reference object attached to the structure included in the captured image is successfully detected, coordinate axes of the structure included in the captured image and coordinate axes of the model may be displayed so that the user may arbitrarily select a predetermined number of edge lines and a predetermined number of ridge lines. Accordingly, the display control apparatus 100 may perform association between the arbitrary edge lines and the corresponding ridge lines.

In this way, the display control apparatus 100 obtains a captured image including a structure obtained by imaging performed by an imaging apparatus. Furthermore, the display control apparatus 100 extracts a plurality of edge lines from the obtained captured image. When detecting a reference object in the obtained captured image, the display control apparatus 100 obtains a predetermined number of edge lines in accordance with the position of the reference object from among the plurality of extracted edge lines. The display control apparatus 100 associates each of a predetermined number of obtained edge lines with a corresponding one of the plurality of ridge lines included in the model corresponding to the structure data with reference to the CAD data storage unit 122 which stores the structure data of the structure. The display control apparatus 100 performs display such that the model is superposed on the captured image in an orientation in which positions of the ridge lines individually associated with a predetermined number of edge lines correspond to the positions of the edge lines associated with the ridge lines. As a result, the display control apparatus 100 may simplify an operation of displaying the model on the captured image in a superposing manner.

Furthermore, the display control apparatus 100 individually associates a predetermined number of edge lines with a predetermined number of ridge lines in the plurality of ridge lines included in the model such that the positional relationship among the ridge lines corresponds to the positional relationship among a predetermined number of edge lines. As a result, the display control apparatus 100 may display the model superposed on the structure of the captured image in accordance with the positional relationship among the edge lines and the positional relationship among the ridge lines.

Furthermore, when detecting the reference object positioned on the structure, the display control apparatus 100 obtains a predetermined number of edge lines surrounding the reference object from among the plurality of extracted edge lines. As a result, the display control apparatus 100 may display the model superposed on the structure of the captured image in accordance with the edge lines surrounding the reference object.

Moreover, the display control apparatus 100 obtains a predetermined number of edge lines which forms a shape surrounding the reference object. As a result, the display control apparatus 100 may display the model superposed on the structure of the captured image based on a plane on which the reference object is disposed.

The model includes the reference object corresponding to the reference object included in the captured image in the display control apparatus 100. The display control apparatus 100 specifies coordinate axes of the structure and coordinate axes of the model based on the reference object included in the captured image and the reference object included in the model, respectively, and associates each of a predetermined number of edge lines with a corresponding one of the plurality of ridge lines based on the specified coordinate axes. As a result, the display control apparatus 100 may display the model superposed on the structure of the captured image using the reference object as a reference of the superposing.

Furthermore, it is not necessarily the case that the components in the various units of the drawings are physically configured as illustrated in FIG. 6. Specifically, concrete modes of dispersion and integration of the various units are not limited to those illustrated in the drawings, and all or some of the units may be physically or functionally dispersed or integrated in an arbitrary unit in accordance with various loads or various use states. For example, the first obtaining unit 131, the extraction unit 132, and the second obtaining unit 133 may be integrated. Furthermore, an order of the performed processes illustrated with reference to the drawings is not limited to that described above, and the processes may be simultaneously performed or may be performed in other orders as long as processing content is not contradicted.

Furthermore, all or a number of the various processing functions of the various devices may be executed on a CPU (or a microcomputer, such as a micro processing unit (MPU) or a micro controller unit (MCU)). Furthermore, all or an arbitrary number of the various processing functions may be executed on a program which is analyzed and executed by the CPU (or the microcomputer, such as the MPU or the MCU) or hardware by wired logic.

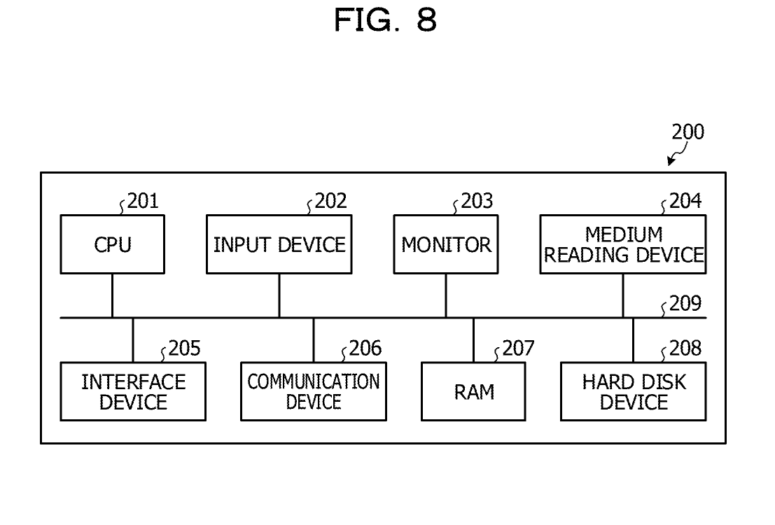

The various processes described in the foregoing embodiment may be realized when programs provided in advance are executed by a computer. Therefore, an example of the computer which executes the programs having the functions of the foregoing embodiment will be described hereinafter. FIG. 8 is a diagram illustrating an example of a computer which executes a display control program.

As illustrated in FIG. 8, a computer 200 includes a CPU 201 which executes various calculation processes, an input device 202 which receives data input, and a monitor 203. The computer 200 further includes a medium reading device 204 which reads programs and the like from a storage medium, an interface device 205 used for connection to various apparatuses, and a communication device 206 used for wired connection or wireless connection to other information processing apparatuses and the like. The computer 200 further includes a RAM 207 which temporarily stores various information and a hard disk device 208. The devices 201 to 208 are connected to a bus 209.

The hard disk device 208 stores a display control program having the functions of the various processing units including the first obtaining unit 131, the extraction unit 132, the second obtaining unit 133, the association unit 134, and the display controller 135 illustrated in FIG. 1. Furthermore, the hard disk device 208 stores various data which realizes the captured image storage unit 121, the CAD data storage unit 122, and the display control program. The input device 202 receives inputs of various information, such as operation information, from a user of the computer 200, for example. The monitor 203 displays various screens including a display screen for the user of the computer 200, for example. The medium reading device 204 reads a captured image and various data including CAD data. The interface device 205 is connected to a printing apparatus, for example. The communication device 206 has the function of the communication unit 110 illustrated in FIG. 1 and is connected to a network, not illustrated, for example, so as to perform transmission and reception of various information with other information processing apparatuses, not illustrated.

The CPU 201 reads various programs stored in the hard disk device 208 and develops and executes the programs in the RAM 207 so as to perform various processes. Furthermore, the programs may cause the computer 200 to function as the first obtaining unit 131, the extraction unit 132, the second obtaining unit 133, the association unit 134, and the display controller 135 illustrated in FIG. 1.

The display control program described above may not be stored in the hard disk device 208. For example, the computer 200 may read and execute a program stored in a storage medium readable by the computer 200. Examples of the storage medium readable by the computer 200 include a portable recording medium, such as a compact disk read only memory (CD-ROM), a digital versatile disk (DVD), or a universal serial bus (USB) memory, a semiconductor memory, such as a flash memory, and a hard disk drive. Furthermore, the display control program may be stored in an apparatus connected to a public line, the Internet, a local area network (LAN), or the like and the computer 200 may read and execute the display control program from the apparatus.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A display control apparatus comprising:
a memory; and
a processor coupled to the memory and the processor configured to:
obtain an image including an object, the image being captured by a camera;
extract a group of edge lines from the image;
determine a plurality of edge lines in accordance with a position of a reference object from among the group of edge lines when the reference object is detected in the image;
execute an association process between each of the plurality of edge lines and each of a plurality of ridge lines included in a model corresponding to structure data of the object, the model being obtained from the memory; and
superimpose the model on the image in a state in which positions of the plurality of ridge lines correspond to positions of the plurality of edge lines respectively.

2. The display control apparatus according to claim 1, wherein the association process includes specifying, from among ridge lines included in the model, the plurality of ridge lines having a positional relationship corresponding to a positional relationship of the plurality of edge lines.

3. The display control apparatus according to claim 1, wherein the reference object is disposed on the object.

4. The display control apparatus according to claim 1, wherein the plurality of edge lines are positioned in vicinity of the reference object in the image.

5. The display control apparatus according to claim 4, wherein the plurality of edge lines surround the reference object in the image.

6. The display control apparatus according to claim 4, wherein a first edge line included in the plurality of edge lines is not in contact with all other edge lines included in the plurality of edge lines.

7. The display control apparatus according to claim 1,
wherein the model includes another reference object corresponding to the reference object, and
the association process includes specifying first coordinate axes of the object on the basis of the reference object included in the image, specifying second coordinate axes of the model on the basis of the other reference object included in the model, and associating each of the plurality of edge lines with each of the plurality of ridge lines respectively on the basis of the first coordinate axes and second coordinate axes.

8. A display control method executed by a computer, the method comprising:
obtaining an image including an object, the image being captured by a camera;
extracting a group of edge lines from the image;
determining a plurality of edge lines in accordance with a position of a reference object from among the group of edge lines when the reference object is detected in the image;
executing an association process between each of the plurality of edge lines and each of a plurality of ridge lines included in a model corresponding to structure data of the object, the model being obtained from the memory; and
superimposing the model on the image in a state in which positions of the plurality of ridge lines correspond to positions of the plurality of edge lines respectively.

9. The display control method according to claim 8, wherein the association process includes specifying, from among ridge lines included in the model, the plurality of ridge lines having a positional relationship corresponding to a positional relationship of the plurality of edge lines.

10. The display control method according to claim 8, wherein the reference object is disposed on the object.

11. The display control method according to claim 8, wherein the plurality of edge lines are positioned in vicinity of the reference object in the image.

12. The display control method according to claim 11, wherein the plurality of edge lines surround the reference object in the image.

13. The display control method according to claim 11, wherein a first edge line included in the plurality of edge lines is not in contact with all other edge lines included in the plurality of edge lines.

14. The display control method according to claim 8,
wherein the model includes another reference object corresponding to the reference object, and
the association process includes specifying first coordinate axes of the object on the basis of the reference object included in the image, specifying second coordinate axes of the model on the basis of the other reference object included in the model, and associating each of the plurality of edge lines with each of the plurality of ridge lines respectively on the basis of the first coordinate axes and second coordinate axes.

15. A non-transitory computer-readable medium storing a display control program that causes a computer to execute a process comprising:
obtaining an image including an object, the image being captured by a camera;
extracting a group of edge lines from the image;
determining a plurality of edge lines in accordance with a position of a reference object from among the group of edge lines when the reference object is detected in the image;
executing an association process between each of the plurality of edge lines and each of a plurality of ridge lines included in a model corresponding to structure data of the object, the model being obtained from the memory; and
superimposing the model on the image in a state in which positions of the plurality of ridge lines correspond to positions of the plurality of edge lines respectively.
